(19) United States
(12) Patent Application Publication
(10) Pub. No.: US 2016/0076466 A1
(43) Pub. Date: Mar. 17, 2016

(54) Method of Controlling an Engine System

(71) Applicant: Perkins Engines Company Limited, Peterborough (GB)

(72) Inventor: Paul Moore, Peterborough (GB)

(73) Assignee: PERKINS ENGINES COMPANY LIMITED, Peterborough (GB)

(21) Appl. No.: 14/842,389

(22) Filed: Sep. 1, 2015

(30) Foreign Application Priority Data
Sep. 15, 2014 (GB) 1416270.5

(51) Int. Cl. F02D 41/00; F02B 37/18; F02B 33/40

(52) U.S. Cl. CPC F02D 41/0007; F02B 33/40; F02B 37/18

(57) ABSTRACT

A method of controlling exhaust gas temperature in an engine system including an internal combustion engine, a supercharger, a supercharger bypass arrangement and an exhaust aftertreatment module. The supercharger bypass arrangement is operable to selectively direct intake gas substantially to the supercharger or to direct the intake gas to the engine substantially bypassing the supercharger. The method includes determining an engine load and selectively controlling operation of the supercharger and supercharger bypass arrangement, based upon the engine load, to control the temperature of the exhaust gas to maintain it in a predetermined temperature range associated with the exhaust aftertreatment module.

### CROSS-REFERENCE TO RELATED APPLICATIONS

This patent application claims the benefit of United Kingdom Patent Application No. 1416270.5, filed Sep. 15, 2014, which is incorporated by reference.

### TECHNICAL FIELD

This disclosure is directed towards a method of controlling an engine system according to different loading conditions to optimise aftertreatment performance by controlling exhaust gas temperature and to optimise engine efficiency.

### BACKGROUND

Turbochargers and/or superchargers may be incorporated in engine systems to compress intake air prior to its delivery into the cylinders of an internal combustion engine. The resulting increased air density within the cylinders may allow for an increased amount of fuel to be injected into the cylinders and effectively combusted, thereby increasing the engine work output.

Engine systems incorporating a turbocharger and/or supercharger may be controlled to match the engine work output to a demanded engine load. An example of such control is disclosed in U.S. Pat. No. 4,730,457, in which an engine system comprises a turbocharger for initially compressing the intake air and a supercharger located downstream of the turbocharger compressor. When the engine speed is lower than a predetermined value NO and the throttle opening degree is less than a predetermined value θ₀ (i.e. low speed, low demanded engine output torque) only the turbocharger compresses the intake air. When engine speed is equal to or lower than a predetermined value N₁, which is lower than N₀, and the throttle opening degree is greater than θ₀ (i.e. low speed, high demanded engine output torque) both the supercharger and turbocharger are operated to compress the intake air. As the engine speed approaches N₀ from N₁ and the throttle opening degree is greater than θ₀ (i.e. mid-range speed, high demanded engine output torque) the supercharger is increasingly bypassed whilst the turbocharger speed is increased. Once the engine speed is above N₀ the supercharger is entirely bypassed and only the turbocharger compresses the intake air. However, such a control method may not result in the engine system being operated at optimum efficiency throughout a broad range of engine loads.

### SUMMARY

The present disclosure provides a method of controlling an engine system, the engine system comprising: an internal combustion engine; a supercharger fluidly connected to the internal combustion engine and operable to compress intake gas; a supercharger bypass arrangement operable to selectively direct intake gas substantially to the supercharger or to direct the intake gas to the engine substantially bypassing the supercharger; and an exhaust aftertreatment module fluidly connected to an outlet of the engine to receive exhaust gas from the engine, wherein the method comprises: determining an engine load; and selectively controlling operation of the supercharger and supercharger bypass arrangement, based upon the engine load, to control the temperature of the exhaust gas to maintain it in a predetermined temperature range, said predetermined temperature range being associated with the exhaust aftertreatment module.

By way of example only, embodiments of a method of controlling an engine system are now described with reference to, and as shown in, the accompanying drawings.

### BRIEF DESCRIPTION OF THE DRAWINGS

FIG. 1 is a schematic view of an engine system of the present disclosure; and

FIG. 2 is a graph illustrating the engine load during a transient response of the engine system of FIG. 1 to a desired engine load.

### DETAILED DESCRIPTION

The present disclosure is generally directed towards a method of operating an engine system which may be implemented in a wide range of different configurations of internal combustion engines. Several different operating modes may be employed at different ranges of engine load.

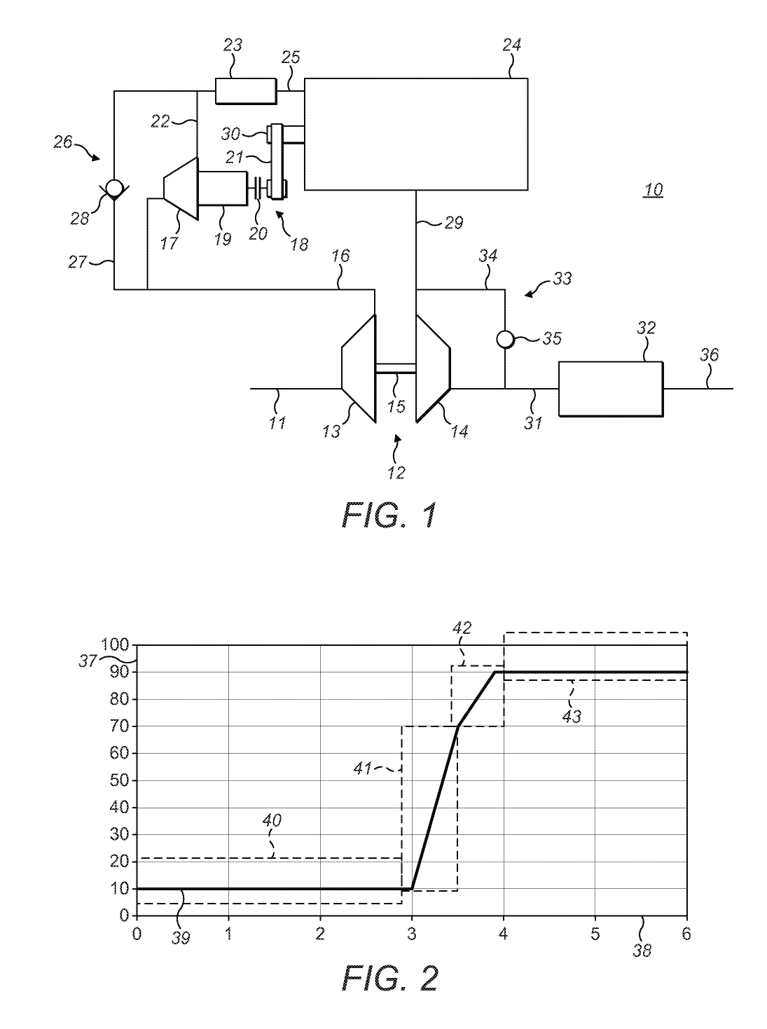

FIG. 1 illustrates an example of an engine system 10 which may be suitable for implementing the method of the present invention. The engine system 10 may comprise a first conduit 11 for directing intake gas, such as atmospheric air, to a turbocharger 12. The turbocharger 12 may comprise a turbocharger compressor 13 connected to the first conduit 11 and arranged to be driven by a turbine 14 via a shaft 15. The turbocharger compressor 13 may be arranged to compress the intake gas to a higher pressure. When the turbocharger compressor 13 is not operable (i.e. being driven), the blades of the turbocharger compressor 13 may be stationary such that intake gas flows through the gaps between them, or they rotate under the reaction force from the intake gas flow only. Alternatively, a turbocharger compressor bypass (not shown) may be provided within the housing of the turbocharger 12, and the intake gas may be substantially directed via the turbocharger compressor bypass when the turbocharger compressor 13 is not in operation.

The engine system 10 may further comprise a supercharger 17 for receiving intake gas from the turbocharger compressor 13 via a second conduit 16. The supercharger 17 may comprise a supercharger compressor for compressing the intake gas. When the supercharger compressor is not in operation, the blades of the supercharger compressor may be stationary such that intake gas flows through the gaps between them or they may rotate under the reaction force from the intake gas flow only. Alternatively, the supercharger compressor may be driven at a speed that results in minimal pressure differential across it. In a further alternative, a supercharger compressor bypass (not shown) may be provided within the housing of the supercharger 17, and the intake gas may be directed via the supercharger compressor bypass when the supercharger compressor is not in operation.

A supercharger drive arrangement 18 may be provided for selectively driving the supercharger 17. An engine 24 may be arranged to provide power to the supercharger 17 mechanically via the supercharger drive arrangement 18. As illustrated, the supercharger drive arrangement 18 may comprise a supercharger transmission 19 having an output connected to the supercharger 17 and a clutch 20 having its output connected to the input of the supercharger transmission 19. The input of the clutch 20 may be arranged to be driven by a belt 21, which is connected to the engine 24. The engine 24 may comprise an engine output shaft 30 to which the belt 21 may be attached, such that when the engine output shaft 30 rotates the input of the clutch 20 rotates. Thus when the clutch 20 is engaged, the supercharger transmission 19 may receive power from the engine 24 and rotate, thereby driving the supercharger 17.

The supercharger transmission 19 may be arranged to direct the power it receives from the engine 24 to the supercharger 17 across a continuous range of output powers. The supercharger transmission 19 may comprise a continuously variable transmission (CVT), which may be of any suitable type known in the art and may provide a broad range of input to output speeds in order to match the range of speeds required by the supercharger 17. For example, the CVT may have a maximum input-output speed ratio of up to 8:1 or 6:1. The supercharger drive arrangement 18 may not have a clutch 20 as described above and instead the supercharger 17 may be “switched off” by controlling the CVT to provide minimal, if any, power to the supercharger 17.

The engine system 10 may further comprise a third conduit 22 for directing the intake gas from the supercharger 17 to a cooler 23. The cooler 23 may be arranged to cool the intake gas before directing it to an engine 24 via a fourth conduit 25. The cooler 23 may be of any suitable type of cooler known in the art and may, for example, be an air-to-air charge cooler.

The engine system 10 may further comprise a supercharger bypass arrangement 26 for allowing intake gas to bypass the supercharger 17 such that intake gas can flow out of the turbocharger compressor 13 directly to the cooler 23. The supercharger bypass arrangement 26 may comprise a supercharger bypass conduit 27 connected between the second and third conduits 16, 22. A supercharger bypass control valve 28 may be provided in the supercharger bypass conduit 27 for selectively controlling the flow of intake gas therethrough. The supercharger bypass control valve 28 may be a one-way check valve and may be a reed valve, a pressure balanced valve, a butterfly valve and/or a manually controlled valve. The supercharger bypass arrangement 26 may enable a full bypass of intake gas around the supercharger 17 such that, due to the pressure restriction around the supercharger 17, when the supercharger bypass control valve 28 is open substantially all of the intake gas may flow through the supercharger bypass arrangement 26 rather than to the supercharger 17.

The engine 24 may be an internal combustion engine such as a compression-ignition or spark-ignition engine. The engine 24 may generally comprise a fluid intake arrangement, such as an inlet manifold, for directing intake gas to a plurality of engine cylinders and a plurality of pistons located in engine cylinders for providing power to a crankshaft via cranks. A throttle valve may be provided in the fluid intake arrangement for controlling the flow rate of intake gas into the cylinders. Fuel, such as diesel, petrol or natural gas, may be selectively provided to the engine cylinders to combust with the intake gas and drive the pistons, thereby rotating the crankshaft and providing an engine output torque and power. The by-product of the combustion process is exhaust gas which may be directed from the engine cylinders along a fifth conduit 29 of the engine system 10 for example, via an exhaust manifold.

The exhaust gas may comprise unwanted gaseous emissions or pollutants, such as nitrogen oxides (NOx), particulate matter (such as soot), sulphur oxides, carbon monoxide, unburnt hydrocarbons and/or other organic compounds. Due to the combustion process the exhaust gas may have a relatively high exhaust gas temperature. As is known in the art, the exhaust gas temperature may depend upon the engine load and for a compression-ignition engine may be in the range of 200° C. to 500° C.

The fifth conduit 29 may direct exhaust gas from the engine 24 to the turbine 14 of the turbocharger 12. The turbine 14 may comprise a plurality of fixed blades attached to a turbine shaft (not shown). The blades may be designed and positioned to ensure that the turbine 14 operates at maximum efficiency when the turbocharger 12 is operating at the maximum required compression ratio.

The engine system 10 may further comprise a sixth conduit 31 for directing exhaust gas from the turbine 14 to an exhaust aftertreatment module 32. A turbine bypass arrangement 33 may be provided for selectively allowing exhaust gas to bypass the turbine 14 (i.e. as a “full” bypass) such that fluid may flow out of the engine 24 directly to the exhaust aftertreatment module 32. The turbine bypass arrangement 33 may comprise a turbine bypass conduit 34 connected between the fifth and sixth conduits 29, 31. A turbine bypass control valve 35 may be provided in the turbine bypass conduit 34 for selectively controlling the flow of exhaust gas therethrough.

A number of turbochargers in the art comprise wastegates. A wastegate is a passageway built into the housing of a turbocharger for bypassing a turbine. The passageway usually contains a poppet valve, which may be very small and externally actuated. The passageway may have a relatively small flow area such that the exhaust gas bleeds past the turbine. However, wastegates may not be designed to provide a full bypass for the exhaust gas around the turbine due to the small flow area. A full bypass, as may be provided by the turbine bypass arrangement 33, may provide the same function as a wastegate. However, the method of the present disclosure may be equally applicable to engine systems comprising a wastegate.

The exhaust aftertreatment module 32 may receive and treat the exhaust gas to remove pollutants prior to directing the exhaust gas to atmosphere via a seventh conduit 36. Exhaust aftertreatment module 32 generally operates effectively at certain temperatures, the efficiency of the exhaust gas treatment being optimised when the exhaust gas temperature is within a predetermined temperature range having lower and upper limits of temperature. This predetermined temperature range may be referred to herein as the “operational temperature range”. The operational temperature range will vary according to the type of exhaust aftertreatment module 32. The operational temperature range may be obtained from the manufacturer of the exhaust aftertreatment module 32 or can be determined by the skilled person from the components used in the exhaust aftertreatment module 32.

The exhaust aftertreatment module 32 may comprise at least one catalyst for oxidising pollutants, such as carbon monoxide and hydrocarbons, and/or for reducing pollutants, such as NOx. The catalyst may be a noble metal or base metal oxide and may be in a catalytic converter, for example being coated over a honeycomb structure or formed on the surface of ceramic pellets. The lower limit may be the temperature at which the catalyst starts to operate effectively and the upper limit may be the temperature at which the catalyst is damaged by heat exposure or stops catalysing effectively. A suitable lower limit may be 180° C. and a suitable upper limit may be 550° C. for a compression-ignition engine running on diesel fuel. When the exhaust gas is passed through the turbine 14 it may reduce in temperature. Therefore, the exhaust gas may have an upper limit of 660° C. prior to entry into the turbine 14.

The exhaust aftertreatment module 32 may comprise a selective catalytic reduction (SCR) system, which may comprise a reductant injector located upstream of a catalyst. The reductant injector may inject a liquid reductant into the stream of exhaust gas entering the exhaust aftertreatment module 32. The high exhaust gas temperature may cause the reductant to evaporate and the resulting combination of gases may contact the catalyst. The reductant may react with the NOx in the exhaust gas to form nitrogen, water and carbon dioxide, which may pass out of the engine system 10 via the seventh conduit 36. In a particular embodiment, the SCR system may be a urea SCR system in which the reductant is aqueous ammonia. The catalyst may comprise zeolites, vanadium or the like.

The SCR system may be more effective when the exhaust gas temperature is within the operational temperature range, such as from 180° C. to 550° C. The SCR system may have a preferred conversion efficiency of at least 95% when the exhaust gas temperature is within the operational temperature range. If the exhaust gas temperature below the lower limit then unwanted compounds, such as ammonium hydrogen sulphate, may form and degrade the performance of the exhaust aftertreatment module 32. If the exhaust gas temperature above the upper limit, the reductant may burn up rather than react with the NOx as required.

The exhaust aftertreatment module 32 may comprise a particulate filter/trap, such as a diesel particulate filter (DPF). If the aftertreatment module 32 comprises an SCR system the particulate filter may be provided upstream of the reductant injector. The particulate filter may be of any suitable form known in the art, for example a ceramic honeycomb, an alumina coated wire mesh or a ceramic foam. The particulate filter may also be of the passively regenerative type in which the filtered particulate material is oxidised from the filter when the exhaust gas temperature is within a predetermined temperature range. Such regeneration requires a relatively high temperature and sufficient nitrogen dioxide in the exhaust gases to be effective as, for example diesel particulate matter oxidises with nitrogen dioxide at around 2500° C. to 400° C. A regenerative filter may comprise a catalyst to allow such ignition to occur at a lower temperature. Alternatively the filter may be actively regenerated by actively raising the temperature of the exhaust gas (such as above 550° C.) adjacent to the filter to the ignition temperature required to achieve oxygen-soot oxidation. The lower limit may be the temperature at which the particulate filter actively regenerates and the upper limit may be the temperature at which the particular filter is damaged by heat exposure.

The engine system 10 may further comprise at least one sensor arranged to sense one or more parameters relating to one or more of the components of the engine system 10 and send signals relating thereto to a control unit. For example, one or more sensing arrangements may be provided to determine or directly detect, in any suitable manner known in the art, the following parameters:
the volume of fuel delivered to each cylinder of the engine 24;
the engine speed, for example by detecting the rate of change in crank angle of the crankshaft;
the volume of fluid flowing into each cylinder prior to combustion;
the temperature and/or pressure within each cylinder;
the temperature and/or pressure of the fluid flowing into the engine system 10 (i.e. the ambient conditions);
the pressure of the fluid at the inlet or outlet of the turbocharger compressor 13, turbine 14 and/or supercharger 17;
the degree of opening of the supercharger and/or turbine bypass control valves 28, 35;
the degree of opening of the throttle valve;
the exhaust gas temperature at the outlet of the engine 24 and/or in the aftertreatment module 32;
the temperature of a coolant fluid within a cooling arrangement for cooling the engine system 10;
the existing drive ratio of the supercharger transmission 19; and
the engagement or non-engagement of the clutch 20.

The control unit may be operable to determine other engine conditions, such as the air to fuel ratio, based upon one or more of these sensed parameters using engine maps (for example lookup tables) and/or empirical models (for example calculations based upon equations). In particular, the control unit may be operable to determine the current engine load, which represents the existing engine torque output, and a desired engine load, which represents a future torque output required of the engine 24.

As is known in the art, the control unit may estimate the current engine load utilising a torque estimator. The torque estimator may be mapped or be an empirical model and may estimate the current engine load based upon, for example, the volume of fuel injected, the engine speed, the ambient temperature/pressure and/or the pressure/temperature of fluid in the fluid inlet of the engine 24. In an alternative example the current engine load may be determined directly utilising a load cell attached to the driveline.

The control unit may determine the desired engine load using a map or model based upon the throttle position and/or volume of fuel to be injected into the cylinders. Alternatively, in a machine in which the engine system 10 provides power to a hydraulic system, the desired engine load may be determined from the pressure of hydraulic fluid in the hydraulic system. For example, a rapid increase in hydraulic fluid pressure may indicate that a high load has been demanded of the hydraulic system. The engine system 10 may need to provide a higher torque output in order to provide sufficient power to the hydraulic system so that it can provide the high load.

The control unit may be operable to control the various components and modules of the engine system 10. For example, the control unit may control the degree of opening of the supercharger and turbine bypass control valves 28, 35, the degree of opening of the throttle valve in the fluid intake, the engagement of the clutch 20, the transmission ratio of the supercharger transmission 19 and/or the rate of fuel injection.

The control unit may further comprise a speed governor which controls the amount of fuel injected based upon the engine speed. Hence the fuel injection may be controlled in accordance with the current engine load rather than the desired engine load.

The control unit may be arranged to operate the engine system 10 in a first, second, third or fourth operating mode.

In the first operating mode the supercharger 17 and turbocharger 12 may provide minimal, if any, compression to the intake gas such that the engine 24 is naturally aspirated. The clutch 20 may be disengaged such that the supercharger 17 is not driven or the supercharger transmission 19 may be operated at a very low ratio such that the supercharger compressor is running at a very low speed and does not compress the intake gas. However, the supercharger bypass control valve 28 may be closed such that intake gas is directed to the supercharger 17. The turbine bypass control valve 35 may be in a fully open position such that the exhaust gas is directed through the turbine bypass conduit 34 instead of the turbine 14.

In the second operating mode the supercharger 17 may be operated to compress the intake gas and the turbocharger 12 may provide minimal or no compression to the intake gas. The supercharger drive arrangement 18 may be engaged to drive the supercharger 17 by engaging the clutch 20 and/or by operating the supercharger transmission 19 at a sufficiently high ratio. The supercharger bypass control valve 28 may be closed such that the intake gas is directed to the supercharger 17. The turbocharger 12 may be bypassed by fully opening the turbine bypass control valve 35.

In the third operating mode both the supercharger 17 and turbocharger 12 may be operated to compress the intake gas. The supercharger 17 may be driven by the supercharger drive arrangement 18. The turbine bypass control valve 35 may be fully closed such that exhaust gas is directed to, and drives, the turbine 14. The turbine 14 drives the turbocharger compressor 13, which compresses the intake gas. The speed at which the supercharger 17 operates may be varied in the third operating mode.

In the fourth operating mode only the turbocharger 12 may be operated to compress the intake gas and the supercharger 17 may be bypassed. The supercharger bypass control valve 28 may be in the fully open position and the supercharger drive arrangement 18 may be disengaged, such that power is not provided to the supercharger 17. This may be, for example, by disengaging the clutch 20 and/or by operating the supercharger transmission 19 at a very low ratio. The turbocharger 12 may be driven by having the turbine bypass control valve 35 in the fully closed position and directing all of the exhaust gas to the turbine 14.

In the method of the present disclosure, these different operating modes may be implemented depending upon the operational state of the engine system 10. The operating modes may be implemented to ensure that the exhaust gas temperature is within the operational temperature range associated with the aftertreatment module 32. The operational temperature range may result in the SCR system operating above the preferred conversion efficiency of approximately 95% when the current engine load is low. Therefore, across the entire vehicle operating cycle (i.e. high and low current loads), the conversion efficiency may be maintained above an average of approximately 98%. The method may be used to avoid an excess air-to-fuel ratio which reduces the exhaust gas temperature below the lower limit whilst maintaining an effective transient response of the engine 24 to a change in desired engine load. As will become apparent, the supercharger 17 may be controlled to ensure that the exhaust gas temperature is above the lower limit.

In the following discussion the different terms used may be defined as follows:
the pumping mean effective pressure (PMEP) may represent the engine power output losses used to drive the supercharger 17 and turbocharger 12;
the frictional mean effective pressure (FMEP) may represent the engine power output losses due to friction in the engine 24;
the brake mean effective pressure (BMEP) may represent the work output of the engine 24 when accounting for energy losses such as the PMEP and FMEP and may be representative of the engine load;
the indicated specific fuel consumption (iSFC) may represent the rate of fuel consumption per unit of power output without taking inefficiency losses into account;
the brake specific fuel consumption (bSFC) may represent the rate of fuel consumption per unit of power output taking inefficiency losses into account; and
the crank angle 50 (CA50) may represent the displacement of the pistons within the cylinders of the engine at which 50% of the fuel has been burnt. A lower CA50 may result in a lower/improved iSFC, but may cause a higher volume of NOx to be produced.

The first or fourth operating modes may be implemented when the engine 24 is at a steady state and the desired load is equal to the current engine load. The first operating mode may be implemented when the current engine load is low and below an engine load threshold value, for example at around 30 to 35% of the maximum output torque of the engine 24. Such an operational state may be referred to as part-load conditions. Thus the engine 24 may be substantially naturally aspirated and the air-to-fuel ratio may be relatively low. As a result, the turbocharger 12 and supercharger 17 may not provide excess air into the engine cylinders, which would cause a reduction in exhaust gas temperature, and the exhaust gas temperature may be provided within the operational temperature range. Furthermore, as no or little power is required to drive the supercharger 17 or turbocharger 12 the PMEP may be minimised such that the bSFC and BMEP are improved. The engine system 10 may also be arranged such that the CA50 is reduced by controlling the fuel injection timing in order to improve the iSFC. The increased NOx output due to this reduction in CA50 may be removed effectively by the aftertreatment module as the exhaust gas temperature is within the predetermined temperature range. The heat rejection by the cooler 23 may also be minimised since less work is required of the cooler 23 to cool the intake gas due to the minimised excess air-to-fuel ratio.

The fourth mode may be implemented when the current engine load is high and above the engine load threshold value at a steady state. Thus the turbocharger 12 is engaged whilst the supercharger 17 is bypassed. The turbine 14 may be arranged and optimised to operate only within the higher load region 43 at a steady state. For example, the turbine 14 may comprise a fixed blade arrangement having a high swallowing capacity when operated within the range of engine loads in the higher load region 43. The optimisation of the turbine 14 and disengagement of the supercharger 17 may reduce the PMEP and thereby improve/reduce the bSFC.

Therefore, the supercharger 17 is not used to compress the intake gas when the engine 24 is in a steady state.

FIG. 2 illustrates a graph showing an exemplary transient response of the engine 24 to a high desired engine load. The vertical axis 37 may represent the engine load as a percentage of the maximum output torque of the engine 24 and the horizontal axis 38 may represent time in seconds. A line 39 may represent an exemplary transient response of the current engine load due to a desired engine load of 90% of maximum output torque.

In a lower load region 40 the engine load may be relatively low, for example from 10% of maximum output torque, and at a substantially steady state. As previously discussed, the first operating mode may therefore be implemented.

In a higher load region 43 the engine load may be relatively high, for example 90% of maximum output torque, and is in a substantially steady state. As previously discussed, the fourth operating mode may therefore be implemented.

In an initial snap response region 41 and a transition snap response region 42 a desired engine load higher than the current engine load may be detected by the control unit. Thus the current engine load may increase from the lower load region 40 to the desired engine load in the higher load region 43 over a short period of time in a transient response known as a snap torque response.

The initial snap response region 41 may be the initial snap torque response as the engine load increases from the lower load region 40. As illustrated the engine load may increase by up to 60% of the maximum output torque in under 0.5 seconds, for example from around 10% to 70%. The second operating mode may be implemented such that the supercharger 17 is driven whilst the turbocharger 12 is bypassed. As a result, the speed of the initial snap torque response may be improved since the immediate engagement of the supercharger 17 via the clutch 20 and/or supercharger transmission 19 may be significantly quicker than if the turbocharger 12 were engaged as in the prior art (due to turbo lag). By implementing the initial snap torque response utilising only the supercharger 17 with its rapid response time, the air-to-fuel ratio within the cylinders need not be kept high in the lower load region 40 as in prior art systems. Thus the exhaust gas temperature may be maintained high enough to fall within the operational temperature range. Furthermore, the PMEP is reduced by not engaging the turbocharger 12 as well as the supercharger 17, thereby improving bSFC and BMEP.

In the transition snap response region 42 the engine load may transition from the peak engine load of the initial snap response region 41 to the steady state engine load of the higher load region 43. The engine load may increase rapidly in the transition snap response region 42, but may increase at a slower rate when compared to the rate of engine load increase in the initial snap response region 41. As illustrated, the engine load may increase by up to 20% over a period of 0.5 seconds. The third operating mode may be implemented such that the supercharger 17 remains engaged whilst the turbocharger 12 is engaged. Thus the transition snap response region 42 may begin once there is sufficient exhaust gas flow to drive the turbine 14, which may be at a predetermined BMEP set point. The supercharger transmission 19 may be operated to reduce the gear ratio such that as the engine load approaches that of the higher load region 43 the compression by the supercharger 17 is gradually reduced until it is disengaged in the fourth operating mode. Therefore, the supercharger 17 may be utilised to compensate for any turbo lag resulting from the engagement of the turbocharger 12 until the turbocharger 12 is operating at full capacity.

### INDUSTRIAL APPLICABILITY

In prior art systems a turbocharger is commonly only engaged when an associated engine is at a low speed and there is a low demanded engine output torque. This may form an excess air-to-fuel ratio in cylinders of the engine. The excess air-to-fuel ratio may be necessary in order to ensure that there is sufficient air in the cylinders such that the engine can provide a sufficiently quick transient response to a high desired engine load. The turbocharger turbine may further be arranged to operate over an entire range of engine loads, for example by including variable geometry blades. The excess air-to-fuel ratio may cause the exhaust gas temperature to be relatively low. The performance of some aftertreatment modules for cleaning pollutants from the exhaust gases, particularly SCR systems and DPFs, may therefore be affected by the low exhaust gas temperatures. The aftertreatment strategy of prior art systems accounts for this by, for example, including catalysts which are reactive at low temperatures, special filters or the like. Alternatively, the exhaust gas temperature may be raised using throttles or back-pressure valves in the exhaust gas stream. However, whilst the engine may thus be operated in order to reduce pollutant production, it may not operate at maximum output torque efficiency.

As will be apparent, the method of the present disclosure may ensure that the exhaust gas temperature is within the operational temperature range associated with the exhaust aftertreatment module 32 and the engine 24 may be operated at optimum efficiency over the full range of engine loads. Furthermore, the method of the present disclosure may provide various other improvements over the prior art.

The avoidance of a high excess air-to-fuel ratio in the lower load region 40 may mean that the exhaust gas temperature is higher than in an equivalent prior art systems and thus over the lower limit. Therefore, the various thermal management strategies employed in the prior art, such as additional catalysts in the exhaust aftertreatment module 32, may not be required.

In the lower load region 40 the CA50 may be optimised in order to improve the iSFC. Such an optimisation may not be possible in prior art systems as the aftertreatment arrangement may not be able to handle the increased NOx output. However, in the present method, the increased NOx output may be treated effectively by the aftertreatment module 32 due to the higher exhaust gas temperature.

As the supercharger 17 is engaged in a snap torque response before the turbocharger, the engine 24 may also be operated at a lower engine speed in the lower load region 40 due to the reduced air-to-fuel ratio. Therefore FMEP may be minimised and bSFC improved.

Furthermore, the method of the present disclosure may avoid the need for variable geometry turbines in the turbocharger 12. Such turbines may be designed to operate over the entire range of engine loads, but not at maximum efficiency at any engine load in particular. Instead, in the present disclosure the turbine 14 may fixed and its geometry optimised to operate more efficiently only in high engine load conditions.

1. A method of controlling an engine system, the engine system comprising:
an internal combustion engine;
a supercharger fluidly connected to the internal combustion engine and operable to compress intake gas;
a supercharger bypass arrangement operable to selectively direct intake gas substantially to the supercharger or to direct the intake gas to the engine substantially bypassing the supercharger; and
an exhaust aftertreatment module fluidly connected to an outlet of the engine to receive exhaust gas from the engine,
wherein the method comprises:
determining an engine load; and
selectively controlling operation of the supercharger and supercharger bypass arrangement, based upon the engine load, to control the temperature of the exhaust gas to maintain it in a predetermined temperature range, said predetermined temperature range being associated with the exhaust aftertreatment module.

2. A method as claimed in claim 1 wherein the engine system further comprises:
a turbocharger fluidly connected to the supercharger bypass arrangement, to an exhaust outlet of the engine and to the exhaust aftertreatment module and operable to compress intake gas; and
a turbocharger bypass arrangement operable to selectively direct exhaust gas from the engine substantially to the turbocharger or to direct the exhaust gas to the exhaust aftertreatment module substantially bypassing the turbocharger;
wherein the method further comprises selectively controlling the operation of the turbocharger bypass arrangement, based upon the engine load, to provide said control of the temperature of the exhaust gas.

3. A method as claimed in claim 1 wherein the aftertreatment module is a selective catalytic reduction system and the predetermined temperature range is the temperature of the exhaust gas at which the selective catalytic reduction system operates at a conversion efficiency of at least 95%.

4. A method as claimed in claim 1 wherein the supercharger is operable to compress the intake gas based on a determination that a current engine load is lower than a predetermined desired engine load and is not at a steady state.

5. A method as claimed in claim 1 wherein in a first operating mode the supercharger bypass arrangement is controlled to substantially direct intake gas to the supercharger and the supercharger is not in operation such that the supercharger does not substantially compress the intake gas.

6. A method as claimed in claim 5 when dependent upon claim 2 wherein in the first operating mode the turbocharger bypass arrangement is controlled to direct exhaust gas substantially to the exhaust aftertreatment module, substantially bypassing the turbocharger.

7. A method as claimed in claim 5 wherein the first operating mode is implemented when the current engine load is below an engine load threshold value and at a steady state.

8. A method as claimed in claim 1 wherein in a second operating mode the supercharger bypass arrangement is operable to direct intake gas substantially to the supercharger and the supercharger is operated to substantially compress the intake gas.

9. A method as claimed in claim 3 wherein in a second operating mode the supercharger bypass arrangement is operable to direct intake gas substantially to the supercharger and the supercharger is operated to substantially compress the intake gas, and wherein in the second operating mode the turbocharger bypass arrangement is controlled to direct exhaust gas substantially to the exhaust aftertreatment module, substantially bypassing the turbocharger.

10. A method as claimed in claim 8 wherein the second operating mode is implemented when a current engine load is lower than a desired engine load.

11. A method as claimed in claim 1 wherein in a third operating mode the supercharger bypass arrangement is controlled to direct intake gas substantially to the supercharger and the supercharger is operated to substantially compress the intake gas.

12. A method as claimed in claim 2 wherein the second operating mode is implemented when a current engine load is lower than a desired engine load, and wherein in the third operating mode the turbocharger bypass arrangement is controlled to direct exhaust gas substantially to the turbocharger and the turbocharger is operated to substantially compress the intake gas which is substantially directed to the supercharger for further compression.

13. A method as claimed in claim 12 wherein the third operating mode is implemented when a current engine load is increasing and a desired engine load is higher than the current engine load.

14. A method as claimed in claim 2 wherein in a fourth operating mode the turbocharger is operated to substantially compress the intake gas and the supercharger bypass arrangement is controlled to direct the intake gas received from the turbocharger substantially to the engine, substantially bypassing the supercharger.

15. A method as claimed in claim 14 wherein in the fourth operating mode the turbocharger bypass arrangement is controlled to direct exhaust gas substantially to the turbocharger and the turbocharger is operated to substantially compress the intake gas.

16. A method as claimed in claim 13 wherein the fourth operating mode is implemented when a current engine load is above an engine load threshold value.

17. A method as claimed in claim 2 wherein the aftertreatment module is a selective catalytic reduction system and the predetermined temperature range is the temperature of the exhaust gas at which the selective catalytic reduction system operates at a conversion efficiency of at least 95%.

18. A method as claimed in claim 2 wherein the supercharger is operable to compress the intake gas based on a determination that a current engine load is lower than a predetermined desired engine load and is not at a steady state.

19. A method as claimed in claim 2 wherein in a first operating mode the supercharger bypass arrangement is controlled to substantially direct intake gas to the supercharger and the supercharger is not in operation such that the supercharger does not substantially compress the intake gas.

20. A method as claimed in claim 2 wherein in a second operating mode the supercharger bypass arrangement is operable to direct intake gas substantially to the supercharger and the supercharger is operated to substantially compress the intake gas.
